(19) United States
(12) Patent Application Publication
(10) Pub. No.: US 2001/0048817 A1
(43) Pub. Date: Dec. 6, 2001

(54) Method and apparatus for digital film processing using a single scanning station

(76) Inventors: George G. Mooty, Austin, TX (US); William D. Mapel, Liberty Hill, TX (US); Robert S. Young JR., Austin, TX (US)

Correspondence Address: DINSMORE & SHOHL, LLP, 1900 CHEMED CENTER, 255 EAST FIFTH STREET, CINCINNATI, OH, 45202, US

(21) Appl. No.: 09/740,727

(22) Filed: Dec. 18, 2000

Related U.S. Application Data
(60) Provisional application No. 60/174,040, filed on Dec. 30, 1999.
(60) Provisional application No. 60/174,189, filed on Dec. 30, 1999.

(51) Int. Cl. G03D 3/00

(52) U.S. Cl. 396/564

(57) ABSTRACT

A method and apparatus for creating a single digital image file from multiple digital images while minimizing cost, complexity, and/or size of the system. A single imaging station is used to generate a plurality of digital images from a medium, each digital image representing the same source image on the medium. The plurality of digital images are combined to create a single digital image which represents the source image. In one exemplary embodiment, the medium is moved a plurality of times in a continuous unidirectional path through the imaging station to create the digital images. The medium can be applied to a transport structure, such as a wheel, which can be rotated to recirculate the medium through the imaging station. The medium can comprise developing film, and the imaging station can comprise a front source, a front sensor, a back source, and a back sensor.

This application claims the benefit of U.S. Provisional Application No. 60/174,040, filed Dec. 30, 1999, and U.S. Provisional Application No. 60/174,189, filed Dec. 30, 1999, the entire disclosures of which are hereby incorporated herein by reference.

### TECHNICAL FIELD

The present invention relates generally to digital film development, and more particularly to a method and apparatus for scanning film multiple times using a single scanning station.

### BACKGROUND OF THE INVENTION

Color photographic film generally comprises three layers of light sensitive material that are separately sensitive to red, green, and blue light. During conventional color photographic film development, the exposed film is chemically processed to produce dyes in the three layers with color densities directly proportional to the blue, green and red spectral exposures that were recorded on the film in response to the light reflecting from the photographed scene. Yellow dye is produced in the top layer, magenta dye in the middle layer, and cyan dye in the bottom layer, the combination of the produced dyes revealing the latent image. Once the film is developed, a separate printing process can be used to record photographic prints, using the developed film and photographic paper.

In contrast to conventional film development, digital film development systems, or digital film processing systems, have been proposed. One such system involves chemically developing exposed film to form scene images comprised of silver metal particles or grains in each of the red, green, and blue recording layers of the film. Then, while the film is developing, it is scanned using electromagnetic radiation, such as light with one predominant frequency, preferably in the infrared region. In particular, as the film develops in response to chemical developer, a light source is directed to the front of the film, and a light source is directed to the back of the film. Grains of elemental silver developing in the top layer (e.g., the blue sensitive layer) are visible from the front of the film by light reflected from the front source; however, these grains are substantially hidden from the back of the film. Similarly, grains of elemental silver developing in the bottom layer (e.g., the red sensitive layer) are visible from the back of the film by light reflected from the back source; however these grains are substantially hidden from the front. Meanwhile, grains of elemental silver in the middle layer (e.g., the green sensitive layer) are substantially hidden from the light reflected from the front or back; however, these grains are visible by any light transmitted through the three layers, as are those grains in the other two layers. Thus, by sensing, for each pixel location, light reflected from the front of the film, light reflected from the back of the film, and light transmitted through the film, three measurements can be acquired for each pixel. The three measured numbers for each pixel can then be solved for the three colors to arrive at three color code values for each pixel, and the plurality of colored pixels can then be printed or displayed to view the image.

If desired, such scanning of each image on the film can occur at multiple times during the development of the film. Accordingly, features of the image which may appear quickly during development can be recorded, as well as features of the image which may not appear until later in the film development. The multiple digital image files for each image can then be combined to form a single enhanced image file.

While multiple scans can be created through the use of multiple scanning stations, such a system requires redundant hardware, which can add to the cost, complexity, and size of the system. While the film could be moved in forward and reverse through a single scanning station, such a solution involves time in switching from forward to reverse (in addition to associated equipment), as well as the complexity in aligning and combining multiple digital image files, some of which were taken during forward movement and some of which were taken during reverse movement. Accordingly, it is desirable to provide a digital film processing system with reduced expense, size, and/or complexity.

### SUMMARY OF THE INVENTION

According to an embodiment of the invention, a method and apparatus for creating a single digital image file from multiple digital images is provided. A single imaging station is used to generate a plurality of digital images from a medium. Each digital image represents the same source image on the medium. The digital images are combined to create a single digital image which represents the source image. The medium can comprise developing film, and the imaging station can comprise a front source to apply radiation to the front of the film, a front sensor to sense radiation from the front of the film, a back source to apply radiation to the back of the film, and a back sensor to sense radiation from the back of the film.

According to another aspect of the invention, a digital film development system is provided, comprising a source, a sensor, and a transportation mechanism. The source is configured to apply radiation to a developing film strip, and the sensor is configured to sense radiation from the developing film strip. The transportation mechanism is adapted to move the developing film strip relative to the source and sensor multiple times in a continuous unidirectional path.

An advantage of at least one embodiment of the invention is that the size, cost, and/or complexity of a digital film development system is minimized.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which like reference numerals indicate corresponding structure throughout the figures.

FIG. 1 is a perspective view of an exemplary digital film development system which can be used with the methods and apparatus of the present invention;

FIG. 2 illustrates the exemplary operation of the digital film development system of FIG. 1;

FIG. 3 is a side view of a modular digital film development system;

FIG. 4 is a side view of a re-circulating digital film development system, made in accordance with principles of the present invention; and

FIG. 5 is a side view of a circular digital film development system, made in accordance with principles of the present invention.

### DETAILED DESCRIPTION OF EXEMPLARY EMBODIMENTS

In general, the present invention relates to digital film processing system which has lower the cost, complexity, and/or size when compared to other digital film processing systems which utilize multiple imaging stations. In particular, a developing film strip is circulated through a single imaging station multiple times in order to obtain multiple digital images of each frame on the film at multiple film development times. The developing film can be circulated through the single imaging station in a continuous uni-directional path, or by attaching the film to a transport structure, such as a wheel, which is then rotated. For each frame on the developing film, the multiple digital images are combined to form a single digital image which represents the frame and which includes features which appear on the film at the various film development times.

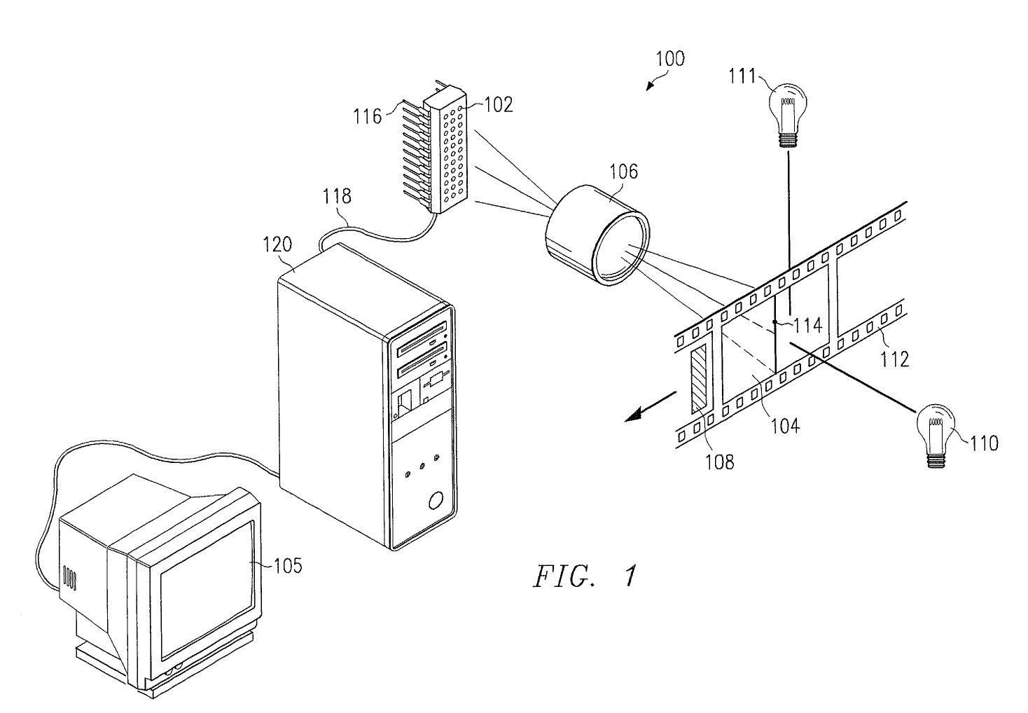

FIG. 1 shows an improved digital film processing system 100. The system operates by converting electromagnetic radiation from an image to an electronic (digital) representation of the image. The image being scanned is typically provided on a photographic film media 112 which is being developed using chemical developer. In many applications, the electromagnetic radiation used to convert the image into a digital representation is infrared light; however, visible light, microwave and other suitable types of electromagnetic radiation may also be used to produce the digitized image. The scanning system 100 generally includes a number of optic sensors 102, which measure the intensity of electromagnetic energy passing through or reflected by the developing film 112. The source of electromagnetic energy is typically a light source 110 which illuminates the film 112 containing the scene image 104 and 108 to be scanned, which are forming on the film during the film development. Radiation from the source 110 may be diffused or directed by additional optics such as filters or waveguides (not shown) and/or one or more lenses 106 positioned between the sensor 102 and the film 112 in order to illuminate the images 104 and 108 more uniformly.

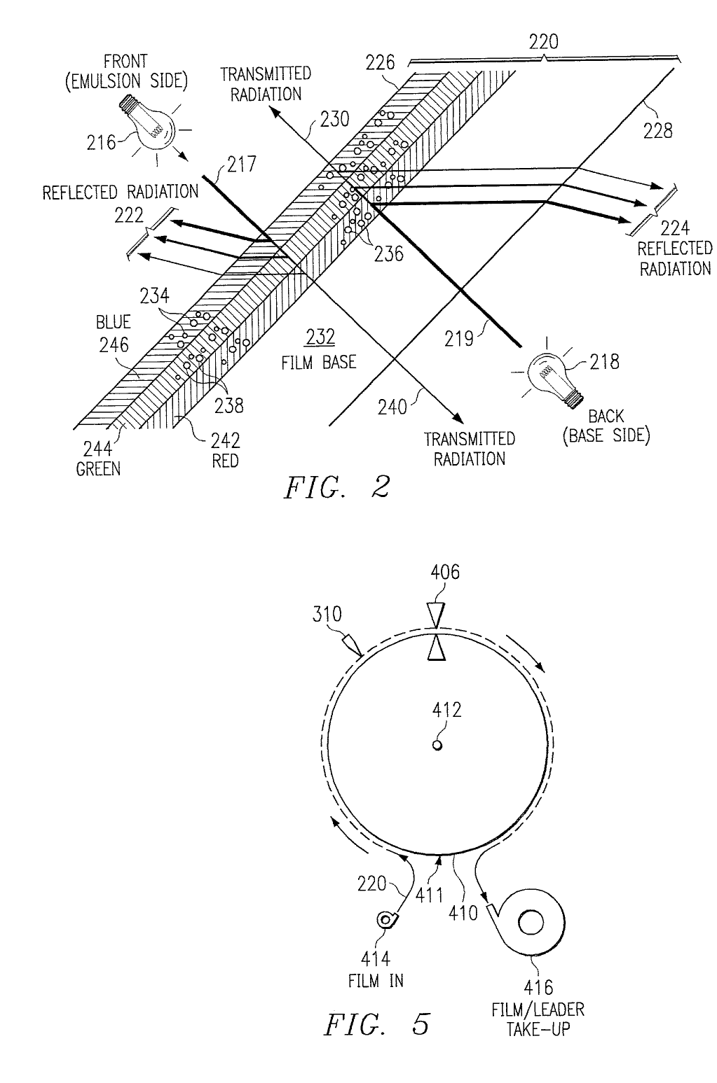

Source 110 is positioned on the side of the film 112 opposite the optic sensors 102. This placement results in sensors 102 detecting radiation emitted from source 110 as it passes through the images 104 and 108 on the film 112. Another radiation source 111 can be placed on the same side of the film 112 as the sensors 102. When source 111 is activated, sensors 102 detect radiation reflected by the images 104 and 108. This process of using two sources positioned on opposite sides of the film being scanned is described in more detail below in conjunction with FIG. 2.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in a scanned image, or digital image file, which comprises a plurality of pixel data. The images 104 and 108 on film 112 can be sequentially moved, or scanned relative to the optical sensors 102. The optical sensors 102 are typically housed in a circuit package 116 which is electrically connected, such as by cable 118, to supporting electronics for storage and digital image processing, shown together as computer 120. Computer 120 can then process the digital image data and display it on output device 105. Alternatively, computer 120 can be replaced with a microprocessor or controller and cable 118 replaced with an electrical connection.

Optical sensors 102 may be manufactured from different materials and by different processes to detect electromagnetic radiation in varying parts and bandwidths of the electromagnetic spectrum. For instance, the optical sensor 102 can comprise a photodetector that produces an electrical signal proportional to the intensity of electromagnetic energy striking the photodetector. Accordingly, the photodetector measures the intensity of electromagnetic radiation attenuated by the images 104 and 108 on film 112.

As previously described and as shown in FIG. 2, the embodiments of the present invention described herein can use duplex film scanning which refers to using a front source 216 and a back source 218 to scan a developing film 220 with radiation 217 and 219 respectively. The applied radiation 217 and 219 results in reflected radiation 222 from the front 226 and reflected radiation 224 from the back 228 of the film 220, as well as transmitted radiation 230 and 240 that passes through all layers of the film 220. While the sources 216, 218 may emit a polychromatic light (i.e., multi-frequency light), the sources 216, 218 can emit monochromatic light, such as infrared light for example. The resulting radiation 222, 224, 240, and 230 are referred to herein as front, back, front-through and back-through, respectively, and are further described below.

In FIG. 2, separate color layers are viewable within the film 220 during development of the red layer 242, green layer 244 and blue layer 246. More specifically, over a clear film base 232 are three layers 242,244,246 sensitive separately to red, green, and blue light, respectively. These layers are not physically the colors; rather, they are sensitive to these colors. In conventional color film development, the blue sensitive layer 246 would eventually develop a yellow dye, the green sensitive layer 244 a magenta dye, and the red sensitive layer 242 a cyan dye.

During chemical development of the film 220, such as by using a developer, layers 242, 244, and 246 are opalescent. Dark silver grains 234 developing in the top layer 246, (the blue source layer), are visible from the front 226 of the film by radiation 222, and slightly visible from the back 228 because of the bulk of the opalescent developer emulsion. Similarly, grains 236 in the bottom layer 242 (the red sensitive layer) are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the developing film 220 from both the front 226 and back 228 of the film, each pixel in the film 220 yields four measured values, that may be mathematically solved for the three colors, red, green, and blue, closest to the original scene. For instance, a matrix transformation may be utilized as described in U.S. Pat. No. 5,519,510, the entire disclosure of which is hereby incorporated herein by reference.

The front signal records the radiation 222 reflected from the illumination sources 216 in front of the developing film 220. The set of front signals for an image is called the front channel (F). The front channel principally, but not entirely, records the attenuation in the radiation from the source 216 due to the silver metal particles 234 in the top-most layer 246, which is the blue recording layer. The front channel also records some attenuation in the radiation which is due to silver metal particles 236, 238 in the red and green layers 242, 244.

The back signal records the radiation 224 reflected from the illumination sources 218 in back of the developing film 220. The set of back signals for an image is called the back channel (B). The back channel principally, but not entirely, records the attenuation in the radiation from the source 218 due to the silver metal particles 236 in the bottom-most layer 242, which is the red recording layer. Additionally, there is some attenuation which is recorded by the back channel which is due to silver metal particles 234, 238 in the blue and green layers 246, 244.

The front-through signal records the radiation 230 that is transmitted through the developing film 220 from the illumination source 218 in back of the film 220. The set of front-through signals for an image is called the front-through channel (T). Likewise, the back-through signal records the radiation 240 that is transmitted through the developing film 220 from the source 216 in front of the film 220. The set of back-through signals for an image is called the back-through channel (T). The front source 216 can be energized at a first instance in time to record the front signal and back-through signal, and the back source 218 can be energized at a separate instance in time to record the back signal and front-through signal. Both through channels record essentially the same image information since they both record attenuation of the radiation 230, 240 due to the silver metal particles 234, 236, 238 in all three red, green, and blue recording layers 242, 244, 246 of the film 220. Accordingly, one of the through channel signals can be disregarded.

Several image processing steps can then be used to convert the illumination source radiation information for each channel (B, F, and T) to the red, green, blue values similar to those procured by conventional scanners for each spot on the film 220. These steps are needed because the silver metal particles 234, 236, 238 that form during the development process are not spectrally unique in each of the film layers 242, 244, 246. These image processing steps are not performed when conventional scanners are used to scan film after it has been developed, because the dyes which are formed with conventional chemical color development of film make each film layer spectrally unique. However, just as with conventional scanners, once initial red, green, and blue values are derived for each image, further processing of the red, green, and blue values is usually done to enhance, manipulate, display, and/or print the image.

The exemplary digital film development system shown in FIGS. 1 and 2 can produce multiple digital image files for the same frame, each image file having back, front, and through values according to the method described above. It is desirable to create multiple image files for the same frame at separate development times so that features of the image which appear at various development times can be recorded. During the film development process, the highlight areas of the image (i.e., areas of the film which were exposed to the greatest intensity of light) will develop before those areas of the film which were exposed to a lower intensity of light (such as areas of the film corresponding to shadows in the original scene). Thus, a longer development time will allow shadows and other areas of the film which were exposed to a low intensity of light to be more fully developed, thereby providing more detail in these areas. However, a longer development time will also reduce details and other features of the highlight areas of the image. Thus, in conventional film development, one development time must be selected and this development time is typically chosen as a compromise between highlight details, shadow details and other features of the image which are dependent on the duration of development. However, in the digital film development process of FIGS. 1 and 2, such a compromise need not be made, as digital image files for the same image can be created at multiple development times and combined to produce an enhanced image.

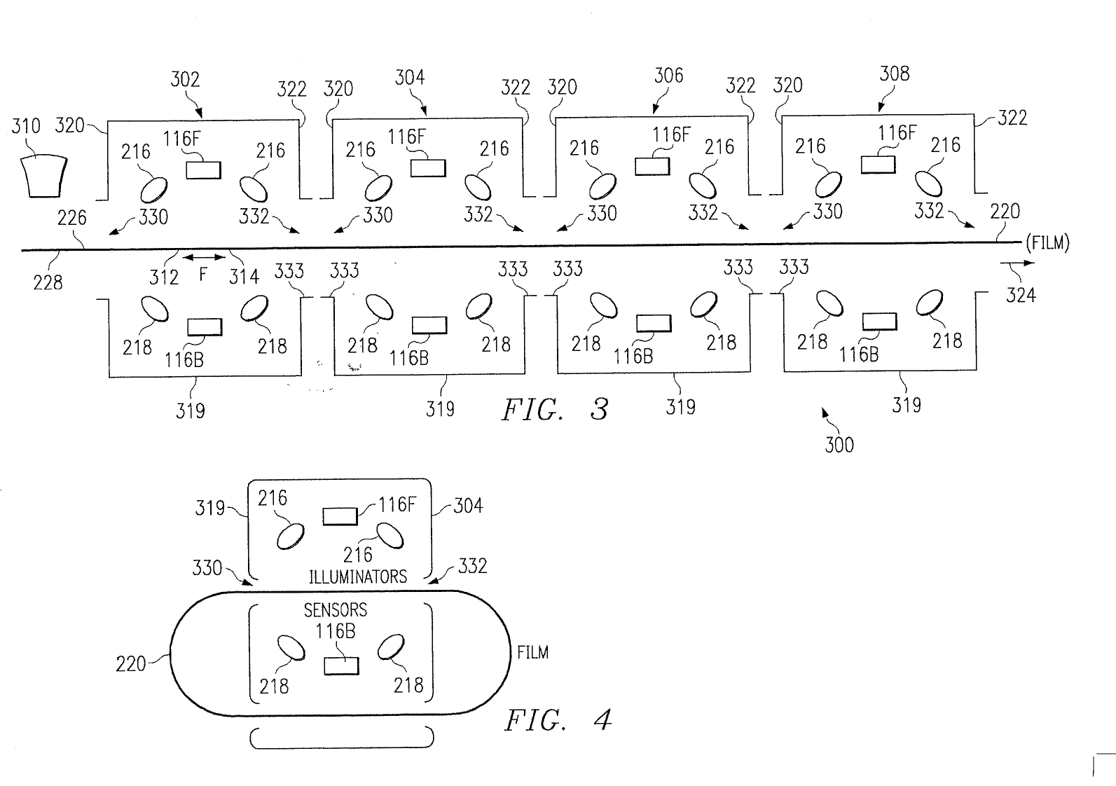

In particular, as shown in FIG. 3, multiple separable scanning modules (i.e., imaging stations or scanning stations) 302, 304, 306, and 308 can be utilized to produce the multiple digital image files of the same image. Each station 302, 304, 306, and 308 in the digital processing system 300 includes a front source 216, a back source 218, a front sensor 116F, and a back sensor 116B, which operate as described above with respect to FIGS. 1 and 2. In particular, with reference to FIGS. 2 and 3, the front sensor 116F detects reflected radiation 222 (generated by front source 216), and also transmitted radiation 230 (generated by the back source 218). Likewise, the back sensor 116B detects the reflected radiation 224 (generated by back source 218), and the transmitted radiation 240 (generated by the front source 216).

Referring now solely to FIG. 3, the stations 302, 304, 306, and 308 are serially connected to form the system 300. This exemplary digital film processing system 300 has a pipeline configuration. Thus, the film travels in the direction 324 from the first station 302, to the second station 304, to the third station 306, to the fourth station 308.

The film 220 can be transported as a continuous strip through the stations 302, 304, 306, and 308 by a suitable film transportation or conveyance system, exemplary embodiments of which are described in more detail below. Because of the time lag between transportation of an image on the film 220 between the stations 302, 304, 306, and 308, each station scans and records a digital image file of a given image at a different development time during the development of the film.

For example, each image or frame on the film, such as frame F which resides between the points 312 and 314, could have developer applied thereto, such as by dispenser 310. The transportation system would then move the frame F to station 302, where a first digital image file is created, using two reflectance signals (a back reflectance signal and a front reflectance signal) and one transmission signal (a back-through signal or a front-through signal) as described above. The frame F would then be transported to station 304 where a second image file is created of the same frame, again using two reflectance signals and one transmission signal. However, because of the predefined time lag in transporting the frame F from the first station 302 to the second station 304, the frame would be scanned by the second station 304 at a later point in the development of the image on the frame F. Thus, some features of the image which might be appearing within the frame F during the development of the film 220 might be captured in the first data image file, but not in the second data image file, and vice versa.

The additional stations 306 and 308 can be connected into the system 300 to provide additional image data files for the frame F at additional development times of the frame. For example, after the second image data file is created for the frame F by the second station 304, a third image data file could be created for the frame F at a later development time by the third station 306 which would obtain two reflectance signals and one transmission signal. Similarly, a fourth image data file could be created by the fourth station 308 at the longest development time, also by obtaining two reflectance signals and one transmission signal. In this manner, four digital representations of the same frame image may be obtained at different development times, such as at 25%, 50%, 75%, and 100% of the total development time, for example. These four digital representations may then be aligned and combined with one another (i.e., stitched together) to form a composite digital representation of the image. This digital representation may be viewed on a video monitor associated with a computer, or printed on a printer connected to computer (such as a laser printer or an ink jet printer) for instance.

As shown in FIG. 3, each station 302, 304, 306, and 308 can be separable from the system 300. Accordingly, although the system 300 is shown with four stations, the system can be easily provided with fewer than four or more than four stations as desired by the user. For instance, if the user desired a system with only three stations to save cost, the station 308 could be disconnected from the station 306 and removed from the system.

However, the system of FIG. 3 requires multiple scanning stations to take multiple images from the same frame at the various development times. In contrast, FIG. 4 is an exemplary digital film development system, made in accordance with principles of the present invention, which reduces the number of scanning stations required, and thereby reduces the size, cost and complexity of the system of FIG. 3. The system of FIG. 4 can still create multiple digital image files of a frame during multiple development times of that frame, but uses only a single scanning station. More specifically, each frame of the film can be scanned at spaced development times by the station 304 by recirculating the film 220 through the station in a uni-directional process. The film moves in the forward direction, and a first scan of a first frame can be taken, a first scan of a second frame taken, etc., until the end of the film has been reached. Then, the film can be looped back, or recirculated, through the station 304, and a second scan of the first frame can be taken, a second scan of the second frame taken, etc. Thus, after the first scan of the first frame has been taken, the first frame will have time to develop, but this time will not be wasted, as the station 304 will be taking other first scans of other frames on the film. This exemplary system and process requires no requires no time or equipment to reverse the film, and no processing steps for interpreting data scanned in reverse.

After all scans are taken for all frames, the first and second scans for the first frame can be digitally stitched together to form the final image for the first frame. Likewise, the first and second scans for the second frame can be digitally stitched together to form the final image for the second frame, and so on. A new film strip to be developed can then be entered into the station 304 through opening 330 and the old strip removed. The film may be transported in any of a variety of manners, such as by using motors, belts, wheels, etc. As shown, the station 304 can include a front source 216 and front sensor 116F, and a back source 218 and back sensor 116B, which operate in a manner similar to the sources and sensors described above with respect to FIGS. 1-3. The sensors 116F and 116B can be configured as a row of sensors such that rows or columns of each frame are scanned sequentially by moving the frame across the row of sensors. The accumulated data taken from the various rows or columns of the frame forms the digital image.

FIG. 5 illustrates an alternative to the system of FIG. 4. As shown in this exemplary embodiment, a film transport wheel 410 can be provided and the film 220 can be supplied from an input reel or canister 414 and secured or placed on the outer surface 411 of the wheel 410. The wheel can then be rotated, such as by using a motor 412, or other rotary driver, to move the film 220 past the scanning station 406 where scanning of the film takes place at a variety of development times. The developer can be applied to the film using a dispenser or coater 310.

Accordingly, in the exemplary configuration of FIG. 5, a particular frame on the film 220 has developer applied by the dispenser 310, and the first scanning of that frame does not begin until the frame is rotated along the wheel 410 to the scanning station 406. Further rotation of the wheel 410 allows other frames on the film to be scanned for the first time by the station 406. The wheel 410 can continue to be rotated 360 degrees from the time the first frame was scanned by the station 406, until the first frame reaches the station a second time, at which time a second scan of the first frame can be taken. Additional scans of the other frames may be taken as well. Once all scans have been taken, the film can be wound on a take-up reel 416. Accordingly, as shown in FIG. 5, a single scanning station 406 can be used to take multiple digital images of the same frame, and these digital images can be combined to form a single enhanced image. Such a station 406 can include a front source 216 and front sensor 116F, and a back source 218 and back sensor 116B, as discussed above with respect to FIGS. 1-3.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. For example, although it is mentioned that the film is moved or recirculated through the imaging station, it is contemplated that the imaging station could be moved instead. In other words, movement of the film relative to the imaging station can be accomplished by moving the film and/or the imaging station. Moreover, although a variety of potential configurations and components have been described, it should be understood that a number of other configurations and components could be utilized without departing from the scope of the invention.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

What is claimed is:

1. A method for creating a single digital image file from multiple digital images, comprising:
using a single imaging station to generate a plurality of digital images from a medium, each digital image representing the same source image on the medium; and
combining the plurality of digital images to create a single enhanced digital image which represents the source image.

2. The method as recited in claim 1, wherein the medium comprises developing film.

3. The method as recited in claim 1, wherein the imaging station comprises a radiation source and a radiation sensor.

4. The method as recited in claim 1, further comprising:
moving the medium through the single imaging station in a continuous uni-directional path.

5. The method as recited in claim 4, wherein the medium is moved by applying the medium to a transport structure and rotating the structure.

6. The method as recited in claim 1, wherein the medium comprises developing film, and the imaging station comprises a back source configured to apply radiation to the back of the developing film, a front source configured to apply radiation to the front of the developing film, a back sensor configured to sense radiation from the back of the developing film, and a front sensor configured to sense radiation from the front of the developing film.

7. The method as recited in claim 1, further comprising:
aligning the plurality of digital images.

8. A method for creating a digital image file from a developing film, comprising:
applying developer to film to cause the film to begin to develop;
positioning a frame on the developing film in front of a source during a first film development period;
during the first film development period, applying radiation to the frame of the developing film using the source;
sensing first radiation from the frame of the film during the first film development period using a sensor;
creating a first digital image file from the sensed first radiation;
returning the frame to the source during a second film development period;
during the second film development period, applying radiation to the frame of the developing film using the source;
sensing second radiation from the frame of the film during the second film development period using a sensor;
creating a second digital image file from the sensed second radiation; and
combining the first and second digital image files to form a combined digital image file which represents the frame.

9. The method as recited in claim 8, wherein each sensing step comprises:
sensing radiation reflected from the front and back of the film and radiation transmitted through the film.

10. The method as recited in claim 8, wherein the positioning and returning steps are conducted by moving the film in the same direction.

11. The method as recited in claim 8, wherein the positioning and returning steps are conducted by moving the developing film in a uni-directional continuous path.

12. The method as recited in claim 11, wherein the moving step is conducted by applying the developing film to a film transport structure and rotating the structure.

13. The method as recited in claim 12, wherein the structure has a circular shape.

14. A digital film development system, comprising:
a source configured to apply radiation to a developing film strip;
a sensor configured to sense radiation from the developing film strip; and
a transportation system adapted to move the developing film strip past the source and sensor multiple times in a continuous unidirectional path.

15. The system as recited in claim 14, wherein the sensor is configured to provide multiple digital images for each frame on the film.

16. The system as recited in claim 15, further comprising:
an image processor configured to combine the digital images for each frame.

17. The system as recited in claim 14, wherein the source comprises a back source configured to apply radiation to the back of the film and a front source configured to apply radiation to the front of the film.

18. The system as recited in claim 14, wherein the sensor comprises a back sensor configured to sense radiation from the back of the film and a front sensor configured to sense radiation from the front of the film.
